(19) United States
(12) Patent Application Publication
(10) Pub. No.: US 2009/0248834 A1
(43) Pub. Date: Oct. 1, 2009

(54) Tiered Architecture and Method for Securely Routing IP-Based Transactions Across the Internet

(75) Inventors: Devarajan Puthupparambil, Rolling Meadows, IL (US); J. Schneider, Grayslake, IL (US)

Correspondence Address: UTSTARCOM, INC., 3800 GOLF ROAD, SUITE 220, ROLLING MEADOWS, IL, 60008, US

(73) Assignee: UTStarcom, Inc., Alameda, CA (US)

(21) Appl. No.: 12/055,046

(22) Filed: Mar. 25, 2008

(51) Int. Cl. G06F 15/16

(52) U.S. Cl. 709/218

(57) ABSTRACT

A method for transaction routing is provided. The method begins by initiating a call session at a transaction terminal and routing the call session from the transaction terminal to a first communication gateway over a secure public network. A routing condition is determined at the first communication gateway. Based on the routing condition, the call session is routed to a second communication gateway or is conducted at the first communication gateway. A transaction routing system operating on the method is also provided.

### BACKGROUND

The invention relates generally to Internet Protocol based transaction sessions, and more specifically, to a system and method for routing secure transactions over an Internet Protocol based communication network.

Secure transactions over public Internet Protocol (IP) networks, between Internet Protocol Point-of-Sale (IP POS) terminals and host servers are made possible by aggregating Secure Sockets Layer (SSL) connections from IP POS terminals and routing them to the host servers. This operation is performed by a transaction gateway.

With IP-based transactions becoming more prevalent, the service regions of the individual service providers will potentially grow much larger. A larger service region can restrict the efficient routing of transactions across the Internet as the authorizing host servers are located at specific locations. This is because the efficiency of the transaction routing greatly depends on the network topology, capacity of the transaction gateways, and, distance from the host servers, among other factors, which in turn depend on the size of the service region. Another aspect critical to any IP-based transaction processing is the security of data in transit. Large network topologies and longer distance from the host servers further contributes to the complexity of the problem in terms of security administration.

One approach to improve or maintain the efficiency of transaction routing, while scaling up the system, is to optimize the network topology. However, this approach may not be feasible when the entire network is considered, because the existing network is already laid out and the complexity of the network topology increases with the network size. Another approach is to arrange the transaction gateways in close proximity to each other or in a private network where the host server is located, so that the data can be transferred to the host server in plain text format. This would, however, significantly limit the possibilities of deploying the systems for handling millions of transactions across a wide geography.

There is therefore a need for techniques to provide routing capabilities to the traffic over the Internet, securely and efficiently, without any geographical distance limitations.

### SUMMARY

According to one aspect of the present techniques, a secure transaction routing system that includes several first communication gateways and second communication gateways is provided. Each of the various first communication gateways is linked to at least one transaction terminal. The second communication gateways are linked to at least one host server. At least one of the first communication gateways is linked to at least one of the second communication gateways over a secure public network.

According to another aspect of the present techniques, a method for transaction routing is provided. The method begins by initiating a call session at a transaction terminal and routing the call session from the transaction terminal to a first communication gateway over a secure public network. A routing condition is determined at the first communication gateway. Based on the routing condition, the call session is routed to a second communication gateway or is conducted at the first communication gateway.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an exemplary tiered architecture in an IP-based transaction processing system, in accordance with aspects of the present techniques; and

FIG. 2 is a flow diagram illustrating an exemplary method of protocol handling and distribution in the IP-based transaction processing system of FIG. 1, in accordance with aspects of the present techniques.

### DETAILED DESCRIPTION OF EXEMPLARY EMBODIMENTS

In the following paragraphs, an approach for utilizing a tiered architecture for Internet Protocol (IP) based transaction processing will be explained in detail. The architecture and the approach described hereinafter presents a technique for securely routing IP-based transactions over the Internet. Such transaction routing is performed with an IP-based Point-of-Service (IP POS) terminal where the transaction is initiated and routed to communication gateways and subsequently to host servers. An IP POS terminal as used in this context may be defined as a transaction terminal facilitating different types of electronic transactions, which may include, in one embodiment, a Point-of-Sale terminal that is commonly used to retail credit or debit transactions. The transactions performed over the IP POS terminals and the IP-based networks are processed securely via the use of various IP protocols, transaction protocols, and, security or authentication and authorization protocols. As will be appreciated by those of ordinary skill in the art, the technique is applicable to various systems that perform secure transactions over IP-based networks. Indeed, the exemplary uses and implementations described herein are merely provided as examples to facilitate understanding of the presently contemplated techniques. Therefore, the various aspects of the present technique will be explained, by way of examples only, with the aid of figures hereinafter.

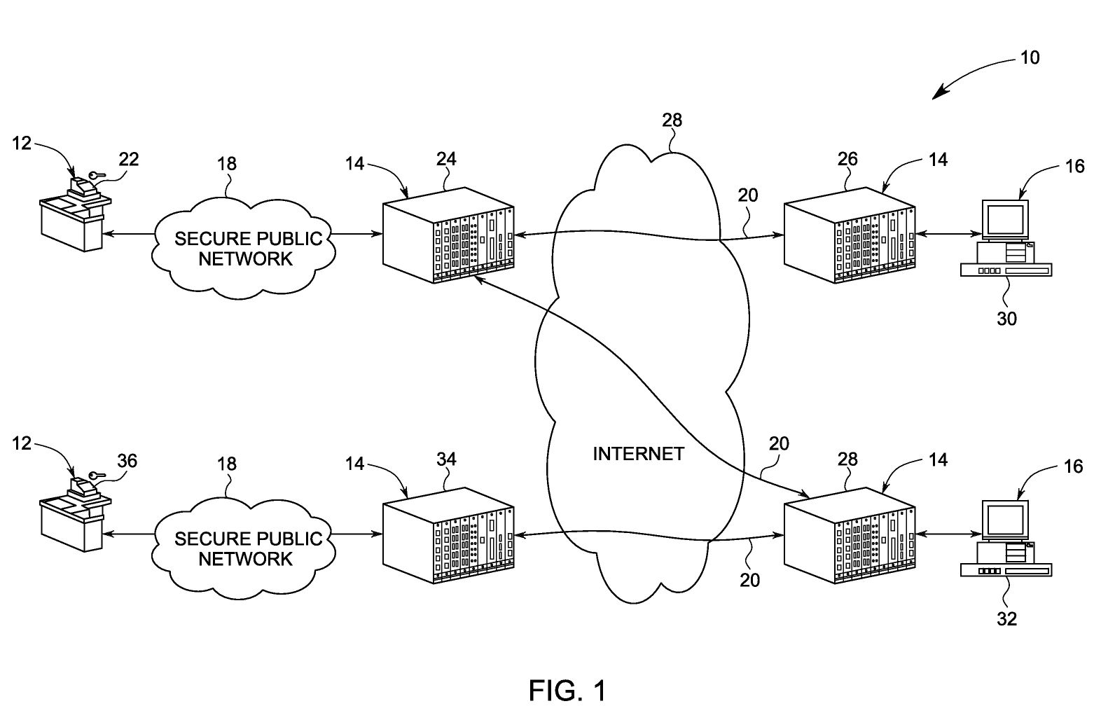

Referring generally to FIG. 1, the transaction processing and routing process will be described by reference to an exemplary transaction processing system designated generally by numeral 10. It should be appreciated however, that the transaction processing system 10 may find application in a range of settings and systems, and that its use in transaction processing described herein is but one such application. As will be explained in detail, the transaction processing system 10 is employed in various kinds of applications ranging from simple POS transactions to more complex communications, such as for example, a secure access, a secure message exchange between two devices, and the like.

The transaction processing system 10 includes IP POS terminals 12 deployed at various retail locations, communication gateways or transaction gateways 14 arranged across regions, and host servers 16 positioned at specific locations. The IP POS terminals 12 are communicatively coupled to communication gateways 14 through a secure public network 18, such as but not limited to a Secure Sockets Layer (SSL) network over the Internet or an Internet Protocol Security (IPSec) connection. Various communication gateways 14 may be communicatively coupled to each other over a secure public network, such as the Internet, via secure protocol links like IPSec connections 20. Many communication gateways 14 are further communicatively linked to host servers 16 over a secure private network, such as via a simple socket connection like Transmission Control Protocol (TCP) socket connection, a Transmission Control Protocol/Internet Protocol (TCP/IP) network, or a non-secure connection.

Each of the IP POS transaction terminals 12, deployed at various establishments, such as shops, are capable of accepting or performing a financial transaction through a credit card, a debit card, or any such financial instrument as may be contemplated by one of ordinary skill in the art. Similarly, the transaction terminal 12 is also capable of handling other transactions such as a secure access or a secure message exchange. The various communication gateways 14 are preferably configured to convert an incoming communication that uses a certain transaction protocol into an aggregated outgoing communication that uses the host-compatible transaction protocol in Layer 7. Therefore, it serves to facilitate compatible communication exchanges between multiple end users (such as various IP POS terminals 12) and, for example, an authorization host or the host server 16.

The host server 16 may similarly include a host socket connection, which links to the communication gateway 14 and facilitates provision of the abovementioned outgoing communication that is aggregated with respect to Layer 3. Those skilled in the art would recognize that a range of other IP protocols or socket connections may be utilized, such as but not limited to Network Time Protocol (NTP), User Datagram Protocol (UDP), Domain Name System (DNS), Lightweight Directory Access Protocol (LDAP), Routing Information Protocol (RIP) and its IP versions of RIP, RIPv1, RIPv2, and RIPng, Open Shortest Path First (OSPF), as presently known, or others hereafter developed. The transaction protocols supported by the communication gateway 14, in order to conduct a transaction, includes VISAI (EIS 1051), VISAII (EIS 1052), ISO 8583, Transport Protocol Data Unit (TPDU), Transparent protocol, and, various custom protocols as are known in the art to facilitate interaction between host servers 16 and transaction terminals 12.

In one exemplary embodiment, an IP POS transaction terminal 22 is connected to a Tier 1 transaction gateway, such as a first communication gateway 24 through a regional IP network or a secure public network 18, such as the Internet. This connection may be established via a secure protocol link, such as a Secure Sockets Layer (SSL) session 26. The first communication gateway 24 may be further linked to a Tier 2 transaction gateway, such as a second communication gateway 26 over a secure public network 28 like the Internet by establishing security protocol link, such as an IPSec tunnel 20. The IPSec tunnel 20, established between a Tier 1 and a Tier 2 transaction gateway, facilitates the direction of call session or the transaction session from the Tier 1 transaction gateway to a particular host server 16. It may be worth noting that a Tier 1 transaction gateway may be linked to multiple Tier 2 transaction gateways, depending on the specific host servers that the Tier 1 transaction gateway would communicate with. For example, as described above and illustrated in FIG. 1, the Tier 1 transaction gateway 24 is linked to two Tier 2 transaction gateways 26 and 28 through IPSec tunnel links 20 established over the Internet. In other words, in this exemplary configuration, the Tier 1 transaction gateway 24 will be configured with the destination addresses of Tier 2 transaction gateways 26 and 28, which are respectively connected to host servers 30 and 32. The Tier 2 transaction gateways 26 and 28, therefore, may be located in close proximity to the host servers 16. In such a tiered architecture, the Tier 1 transaction gateway 24 is the SSL termination point for the transaction terminal 12. Therefore, the Tier 1 transaction gateway 24 may be located at a regional center where the services are offered. Furthermore, the required transaction protocols and security parameters may be configured on the Tier 1 transaction gateway 24.

Similarly, a Tier 2 transaction gateway 28 can be linked to multiple Tier 1 transaction gateways 24 and 34 through IPSec tunnel links 20. Such multiple links 20 may be based on those Tier 1 transaction gateways 24 and 34, which would communicate with a specific host server 32 corresponding to the Tier 2 transaction gateway 28. It may be noted that in such an implementation, it is possible to utilize the Tier 2 transaction gateway 28 as Tier 1 transaction gateway for the IP POS terminals 22 and 36 connected to them in a region where the host server 32 is located. In other words, if the IP POS terminals 22 and 36 and the host server 32 are collocated, only one tier of communication gateway may suffice, or the Tier 2 transaction gateway can act as a Tier 1 transaction gateway.

This kind of tiered approach allows the routing of traffic across the Internet securely and efficiently and eases any restrictions the operators might have in terms of geographic distance specific limitations. Therefore, the host servers 16 can be located anywhere in a country, and seamless and secure transportation of the transactions can be maintained across the country.

The configuration of a pair of Tier 1 and Tier 2 transaction gateways 14 can be defined according to the specifications of the service provider. For example, in one embodiment, the service provider can configure the Tier 1 transaction gateway 24 or 34 in transparent protocol mode for operation, while configuring the Tier 2 transaction gateway 26 or 28 in a mode required for the specific transaction protocol by the IP POS terminal 12. In a second embodiment, the Tier 1 transaction gateway 24 or 34 may be configured with specific transaction protocols as required by the IP POS terminal 12, and the corresponding Tier 2 transaction gateway 26 or 28 can be operated in a transparent protocol mode, while forwarding the data to the host server 16. Furthermore, in a highly distributed transaction handling scenario, these roles could be further modified to allow partial processing to be done at the Tier 1 transaction gateway 24 or 34 with the remaining processing performed at the Tier 2 transaction gateway 26 or 28 as defined by the configuration. The ratio in which the protocols are handled by the pair of the Tier 1 and Tier 2 transaction gateways is, in such an implementation, based on several dynamic conditions, such as the load threshold on each component, the call traffic volume handled, network status, or, predefined conditions, among other parameters.

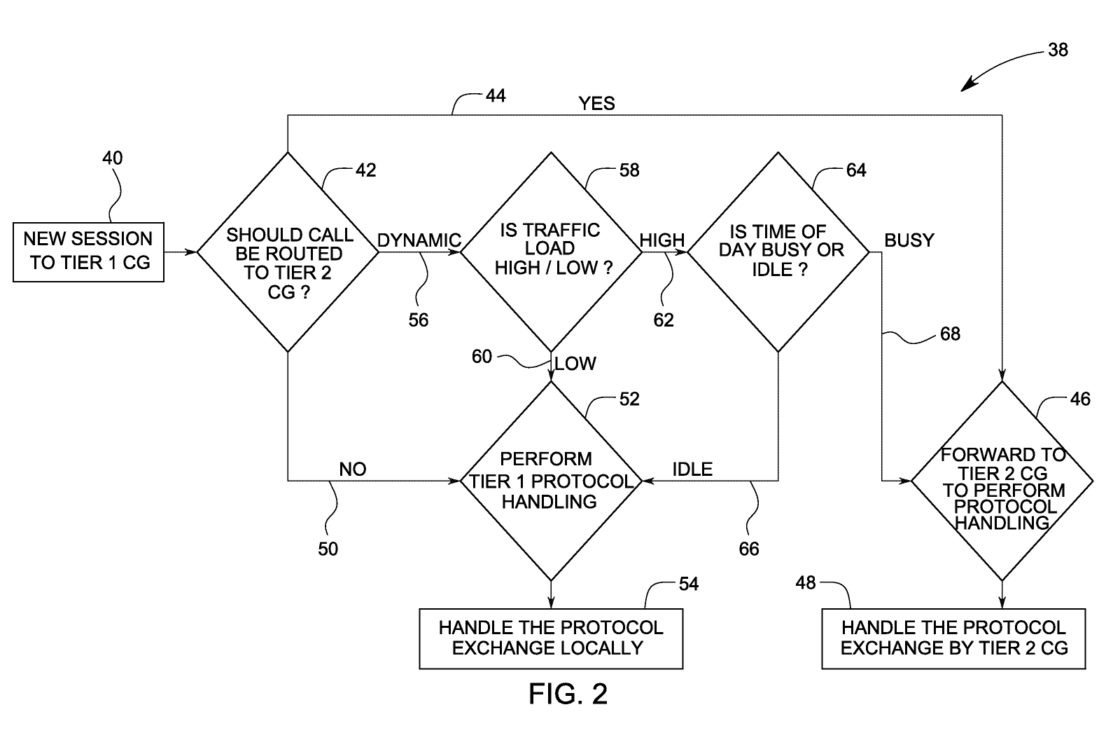

This tiered approach exploits the routing capabilities of the transaction gateways to determine the shortest path route or the least cost route for reaching the Tier 2 transaction gateways from Tier 1 transaction gateways. When the transaction gateways are provided with alternative hosts, they can dynamically determine the most optimal Tier 2 host server for a specific transaction based on the traffic towards that direction at a given time of the day, or day of the week, or the like. This will become apparent when the technique is described with reference to FIG. 2.

Turning now to FIG. 2, a flow diagram 38 illustrating an exemplary method of protocol handling and distribution in the IP-based transaction processing system 10 of FIG. 1 is provided. The flow diagram 38 begins with the initiation of a call session at a transaction terminal 22. This generates 40 a new session at the Tier 1 transaction gateway 24. Depending upon the load threshold on the Tier 1 transaction gateway 24, the traffic handled, or, predefined conditions, a routing condition is determined at step 42. If the routing condition indicates that the call session should be routed to Tier 2 transaction gateway 26 or 28 by a ‘Yes’ routing condition 44 (or when the routing condition is activated), then the call session is routed 46 to the appropriate Tier 2 transaction gateway 26 or 28, which then executes 48 the protocol exchange locally by Tier 2 transaction gateway. However, if the routing condition indicates that the call session should not be routed to Tier 2 transaction gateway 26 or 28 by a ‘No’ routing condition 50 (or when the routing condition is not activated), then the Tier 1 transaction gateway 24 performs 52 the protocol handling for the call session and executes 54 the protocol exchange locally.

In a different embodiment, the routing condition may indicate that the call session should be dynamically routed 56 to Tier 2 transaction gateway 26 or 28. In such a case, the traffic load is checked at step 58 by Tier 1 transaction gateway 24. If the traffic load is low 60, then the Tier 1 transaction gateway 24 performs 52 the protocol handling for the call session and executes 54 the protocol exchange locally. However, if the traffic load is determined to be high 62, then the time of the day is checked at step 64 to determine if it is busy or idle. In this case, if the determination at step 64 indicates that the time of the transaction is pre-configured to be idle 66, then the Tier 1 transaction gateway 24 performs 52 the protocol handling for the call session and executes 54 the protocol exchange locally. Alternatively, if the determination at step 64 indicates that the time of the transaction is pre-configured as busy 68, then the call session is routed 46 to the appropriate Tier 2 transaction gateway 26 or 28, which then executes 48 the protocol exchange locally at the Tier 2 transaction gateway.

It will be appreciated by one of ordinary skill in the art that although the approach is described in FIG. 1 with reference to two Tier 2 transaction gateways linked to one Tier 1 transaction gateway, and one Tier 2 transaction gateway linked to two Tier 1 transaction gateways, the technique can be easily scaled up into multiple Tier 1 and Tier 2 transaction gateways, therefore providing higher flexibility and efficiency in routing the call sessions and transactions.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A secure transaction routing system, comprising:
a plurality of first communication gateways, wherein each of the plurality of first communication gateways is communicatively coupled to at least one transaction terminal; and
a plurality of second communication gateways, wherein the plurality of second communication gateways is communicatively coupled to at least one host server, and wherein at least one of the plurality of first communication gateways is communicatively coupled to at least one of the plurality of second communication gateways over a secure public network.

2. The secure transaction routing system of claim 1, wherein each of the plurality of first communication gateways is communicatively coupled to the at least one transaction terminal over a secure public network.

3. The secure transaction routing system of claim 1, wherein each of the plurality of first communication gateways is communicatively coupled to the at least one transaction terminal via at least one secure socket connection.

4. The secure transaction routing system of claim 3, wherein the at least one secure socket connection comprises a socket connection compatible with at least one of Secure Sockets Layer (SSL) and Internet Protocol Security (IPSec) secure connection.

5. The secure transaction routing system of claim 1, wherein the at least one transaction terminal comprises a Point-of-Service transaction terminal.

6. The secure transaction routing system of claim 1, wherein the plurality of second communication gateways is communicatively coupled to at least one host server over a secure private network via a host socket connection, the host socket connection further comprising at least one of a secure Transmission Control Protocol/Internet Protocol (TCP/IP) socket connection, and a non-secure connection.

7. The secure transaction routing system of claim 1, wherein at least one of the plurality of first communication gateways is configured to provide partial processing in transaction routing.

8. The secure transaction routing system of claim 1, wherein at least one of the plurality of second communication gateways is configured to provide partial processing in transaction routing.

9. The secure transaction routing system of claim 1, wherein each of the plurality of first communication gateways and each of the plurality of second communication gateways are configured to provide processing in at least one of a transaction protocol mode or a transparent protocol mode.

10. A method for transaction routing, the method comprising:
initiating a call session at a transaction terminal and routing the call session from the transaction terminal to a first communication gateway over a secure public network;
determining a routing condition at the first communication gateway; and
routing the call session to a second communication gateway or conducting the call session at the first communication gateway, based on the routing condition.

11. The method of claim 10, wherein routing the call session to the second communication gateway comprises conducting the call session at the second communication gateway.

12. The method of claim 10, wherein routing the call session to the second communication gateway comprises executing protocol operations for the call session partially at the second communication gateway.

13. The method of claim 10, wherein routing the call session to the second communication gateway comprises executing the call session at the second communication gateway using at least one of a transaction protocol mode or a transparent protocol mode.

14. The method of claim 10, wherein conducting the call session at the first communication gateway comprises executing protocol operations for the call session partially at the first communication gateway.

15. The method of claim 10, wherein conducting the call session at the first communication gateway comprises executing the call session at the first communication gateway using at least one of a transaction protocol mode or a transparent protocol mode.

16. The method of claim 10, wherein conducting the call session at the first communication gateway comprises conducting the call session between the first communication gateway and a host server.

17. The method of claim 10, wherein routing the call session to the second communication gateway comprises conducting the call session between the second communication gateway and a host server.

18. The method of claim 10, wherein routing the call session to the second communication gateway comprises routing the call session to the second communication gateway based on at least one of a call traffic volume, a time of day, a network status, or a combination thereof.

19. The method of claim 10, wherein routing the call session to the second communication gateway comprises selecting one of a plurality of second communication gateways coupled with the first communication gateway based on a network status.

20. A method for transaction routing, the method comprising:
initiating a call session at a transaction terminal and routing the call session to a first communication gateway;
conducting the call session at the first communication gateway if a routing condition is activated; and
selecting at least one of a plurality of second communication gateways and routing the call session to the at least one of the plurality of second communication gateways if the routing condition is not activated.

21. The method of claim 20, wherein conducting the call session at the first communication gateway comprises executing protocol operations for the call session partially at the first communication gateway using at least one of a transaction protocol mode, a transparent protocol mode, or a combination thereof.

22. The method of claim 20, wherein routing the call session to the at least one of the plurality of second communication gateways comprises executing protocol operations for the call session partially at the second communication gateway using at least one of a transaction protocol mode, a transparent protocol mode, or a combination thereof.
